(19) United States
(12) Patent Application Publication
(10) Pub. No.: US 2026/0019129 A1
(43) Pub. Date: Jan. 15, 2026

(54) METHOD AND APPARATUS FOR TRANSMISSION AND INTERFERENCE CHANNEL STATE INFORMATION REPORTING IN WIRELESS COMMUNICATION NETWORKS

(71) Applicant: Samsung Electronics Co., Ltd., Suwon-si (KR)

(72) Inventors: Ameha Tsegaye ABEBE, Suwon-si (KR); Younsun KIM, Suwon-si (KR); Kyoungmin PARK, Suwon-si (KR); Youngrok JANG, Suwon-si (KR); Hyoungju JI, Suwon-si (KR); Kyungjun CHOI, Suwon-si (KR)

(21) Appl. No.: 19/256,857

(22) Filed: Jul. 1, 2025

(30) Foreign Application Priority Data
Jul. 15, 2024 (KR) 10-2024-0093336

(51) Int. Cl. H04B 7/06; H04B 17/318; H04W 24/10; H04W 72/0453

(52) U.S. Cl. CPC H04B 7/0626; H04B 17/328; H04W 24/10; H04W 72/0453

(57) ABSTRACT

The disclosure relates to a method performed by a user equipment (UE). The method includes receiving, from a base station, information configuring channel measurement resources (CMRs), generating a first subset of the CMRs corresponding to a transmission hypothesis and a second subset of the CMRs corresponding to an interference hypothesis, and transmitting, to the base station, a channel state information (CSI) report including a first CSI for the first subset and a second CSI for the second subset.

### CROSS-REFERENCE TO RELATED APPLICATION(S)

This application is based on and claims priority under 35 U.S.C. § 119(a) of a Korean patent application number 10-2024-0093336, filed on Jul. 15, 2024, in the Korean Intellectual Property Office, the disclosure of which is incorporated by reference herein in its entirety.

### BACKGROUND

### 1. Field

The disclosure relates to the field of 5th generation (5G) and beyond 5G communication networks. More particularly, the disclosure relates to channel state information (CSI) feedback in multiple-input multiple-output (MIMO) system.

### 2. Description of Related Art

Considering the development of wireless communication from generation to generation, the technologies have been developed mainly for services targeting humans, such as voice calls, multimedia services, and data services. Following the commercialization of 5G communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems, a full-duplex technology for enabling an uplink transmission and a downlink transmission to simultaneously use the same frequency resource at the same time, a network technology for utilizing satellites, High-Altitude Platform Stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of Artificial Intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

To meet the demand for wireless data traffic having increased since deployment of 4th generation (4G) communication systems, efforts have been made to develop an improved 5G or pre-5G communication system. Therefore, the 5G or pre-5G communication system is also called a ‘Beyond 4G Network’ or a ‘Post long term evolution (LTE) System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shifting key (FSK) and quadrature amplitude modulation (QAM) Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for a CSI report corresponding to two CSI reporting hypotheses, the first hypothesis for the preferred transmission channel and the second hypothesis for the corresponding interference channel, wherein the communication network is at least one of the Fifth Generation (5G) standalone network, a 5G non-standalone (NAS) network or Sixth Generation (6G) network.

Another aspect of the disclosure is to provide a method and system to configure a UE with a CSI report corresponding to two CSI reporting hypotheses, the first hypothesis for the preferred transmission channel and the second hypothesis for the corresponding interference channel.

Another aspect of the disclosure is to provide a method and system for a UE upon receiving CSI report configuration corresponding to two CSI reporting hypotheses, the first hypothesis for the preferred transmission channel and the second hypothesis for the corresponding interference channel.

Additional aspects will be set forth in part in the description which follows and, in part, will be apparent from the description, or may be learned by practice of the presented embodiments.

In accordance with an aspect of the disclosure, a method performed by a user equipment (UE) is provided. The method includes receiving, from a base station, information configuring channel measurement resources (CMRs), generating a first subset of the CMRs corresponding to a transmission hypothesis and a second subset of the CMRs corresponding to an interference hypothesis, and transmitting, to the base station, a channel state information (CSI) report including a first CSI for the first subset and a second CSI for the second subset.

In accordance with another aspect of the disclosure, a user equipment (UE) is provided. The UE includes at least one transceiver, at least one processor communicatively coupled to the at least one transceiver, and at least one memory, communicatively coupled to the at least one processor, storing instructions executable by the at least one processor individually or in any combination to cause the UE to receive, from a base station, information configuring channel measurement resources (CMRs), generate a first subset of the CMRs corresponding to a transmission hypothesis and a second subset of the CMRs corresponding to an interference hypothesis, and transmit, to the base station, a channel state information (CSI) report including a first CSI for the first subset and a second CSI for the second subset.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from a base station, information configuring channel measurement resources (CMRs), generating a first subset of the CMRs corresponding to a transmission hypothesis and a second subset of the CMRs corresponding to an interference hypothesis, and transmitting, to the base station, a channel state information (CSI) report including a first CSI for the first subset and a second CSI for the second subset.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIGS. 2A and 2B illustrate example wireless transmit and receive paths according to various embodiments of the disclosure;

FIGS. 3A and 3B illustrate an example UE and gNB, respectively according to various embodiments of the disclosure;

FIG. 4 illustrates a cross-polarized MIMO antenna system according to an embodiment of the disclosure;

FIG. 5 illustrates a layout for channel state information reference signal (CSI-RS) resource mapping in an orthogonal frequency division multiple access (OFDM) time-frequency grid according to an embodiment of the disclosure;

FIG. 6 illustrates an example of precoder construction in Type II CSI according to an embodiment of the disclosure;

FIG. 7A illustrates reporting precoding matrices in subband granularity according to an embodiment of the disclosure;

FIG. 7B illustrates a precoding matrix construction for enhanced Type II CSI according to an embodiment of the disclosure;

FIG. 8 illustrates an autoencoder based CSI feedback according to an embodiment of the disclosure;

FIG. 9 depicts an embodiment for an autoencoder based CSI feedback wherein a preprocessing unit transforms the estimated channel to stacked eigenvectors according to an embodiment of the disclosure;

FIG. 10 illustrates a procedure for multi-transmission-reception point (TRP) (mTRP) CSI reporting according to an embodiment of the disclosure;

FIG. 11 illustrates dynamic CMR or TRP selection in mTRP CSI reporting according to an embodiment of the disclosure;

FIG. 12 illustrates a higher layer configuration for CSI reporting corresponding to two CSI reporting hypotheses according to an embodiment of the disclosure;

FIG. 13 illustrates two CMR subsets each subset corresponding to one of the two CSI reporting hypotheses, wherein the CMR subsets are formed from configured CMR set according to an embodiment of the disclosure;

FIG. 14 illustrates a single bitmap based indication for the CMRs in the two CMR subsets according to an embodiment of the disclosure;

FIG. 15 illustrates two bitmaps based indication for the CMRs in the two CMR subsets according to an embodiment of the disclosure;

FIG. 16 illustrates two bitmaps based indication for the CMRs in the two CMR subsets wherein the second bitmap has a variable size depending on the indication in the first bitmap according to an embodiment of the disclosure;

FIG. 17 illustrates uplink control information (UCI) construction aspects for CSI reporting corresponding to two CSI reporting hypothesis according to an embodiment of the disclosure;

FIG. 18 is a block diagram of a terminal or user equipment (UE) according to an embodiment of the disclosure; and

FIG. 19 is a block diagram of a base station (BS) according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operations to be performed on the computer or other programmable data processing apparatus to produce a computer executed process such that the instructions that perform on the computer or other programmable data processing apparatus provide operations for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “^{˜}unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disc (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜,” “second ˜,” etc., as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the disclosure or claims may, in context, be understood to mean that the corresponding operation is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate methods that may be implemented according to the principles of the disclosure, and various modifications may be made to the methods illustrated in the flowcharts of the disclosure. For example, although illustrated as a series of operations, various operations in each drawing or flowchart may overlap, occur in parallel, occur in a different order, or be repeated. In other examples, any operation may be omitted or replaced with another operation.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the disclosure may include a split architecture comprising a central unit (CU) and a distributed unit (DU). In this structure, the CU is configured to process the higher layers of the control and user planes, while the DU is configured to process lower-layer radio resource functions. The embodiments of the disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the disclosure, the expression “transmit a physical channel” may be interpreted as being equivalent to the expression “transmit data or a signal via a physical channel.”

Hereinafter, in the context of the disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the disclosure will be described in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

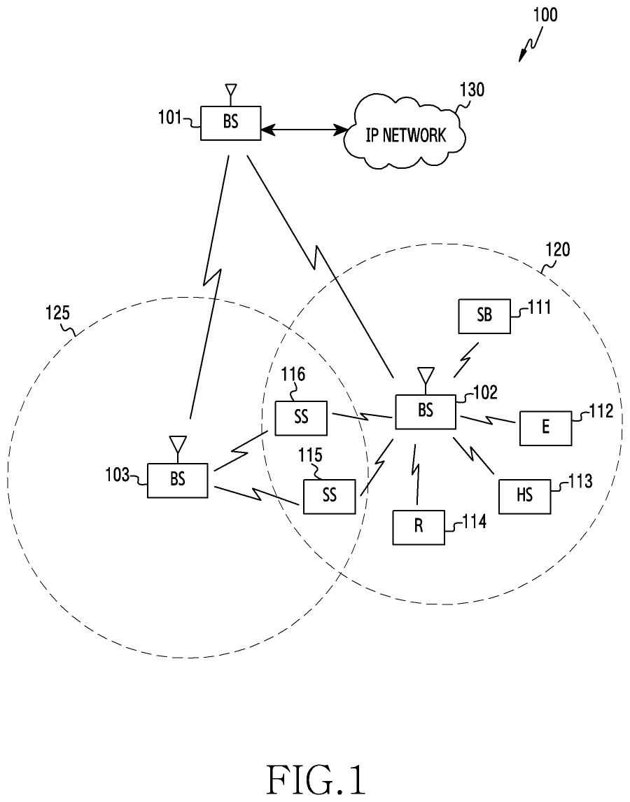

FIG. 1 illustrates an example of a wireless network 100 according to an embodiment of the disclosure.

The embodiment of the wireless network 100 shown in FIG. 1 is for illustration only. Other embodiments of the wireless network 100 can be used without departing from the scope of this disclosure.

The wireless network 100 includes one or more gNodeB (gNB) (e.g., BS 101, BS 102, and BS gNB 103). The BS 101 communicates with the BS 102 and the BS 103. The BS 101 also communicates with at least one Internet Protocol (IP) network (e.g., network 130), such as the Internet, a proprietary IP network, or other data network.

Depending on the network type, the term ‘gNB’ can refer to any component (or collection of components) configured to provide remote terminals with wireless access to a network, such as base transceiver station, a radio base station, a base station, transmission point (TP), transmission-reception point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

The BS 102 provides wireless broadband access to the network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless personal digital assistant (PDA), or the like. The gNB (e.g., BS 103) provides wireless broadband access to the network 130 for a second plurality of UEs within a coverage area 125 of the BS 103. The second plurality of UEs includes the UE 115 and the UE 116. In some embodiments, one or more of the gNBs (e.g., BSs 101-103) may communicate with each other and with the UEs 111-116 using 5G, long-term evolution (LTE), LTE-advanced (LTE-A), worldwide interoperability for microwave access (WiMAX), or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include two-dimensional (2D) antenna arrays as described in embodiments of the disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

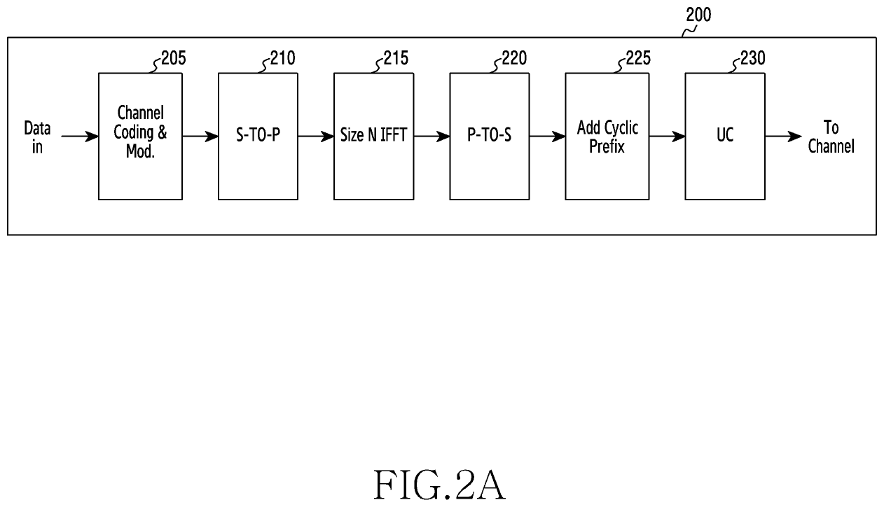

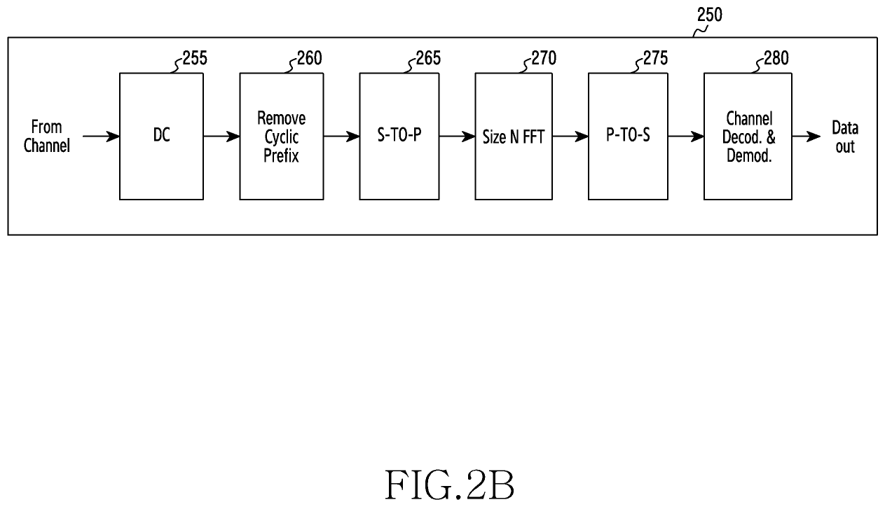

FIGS. 2A and 2B illustrate example wireless transmit and receive paths according to various embodiments of the disclosure.

In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the size N FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

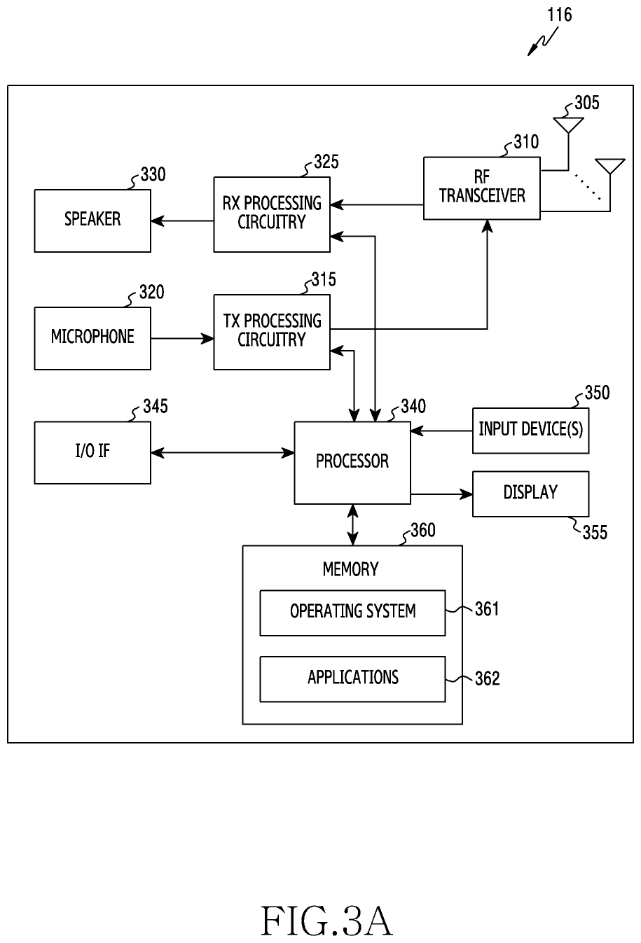

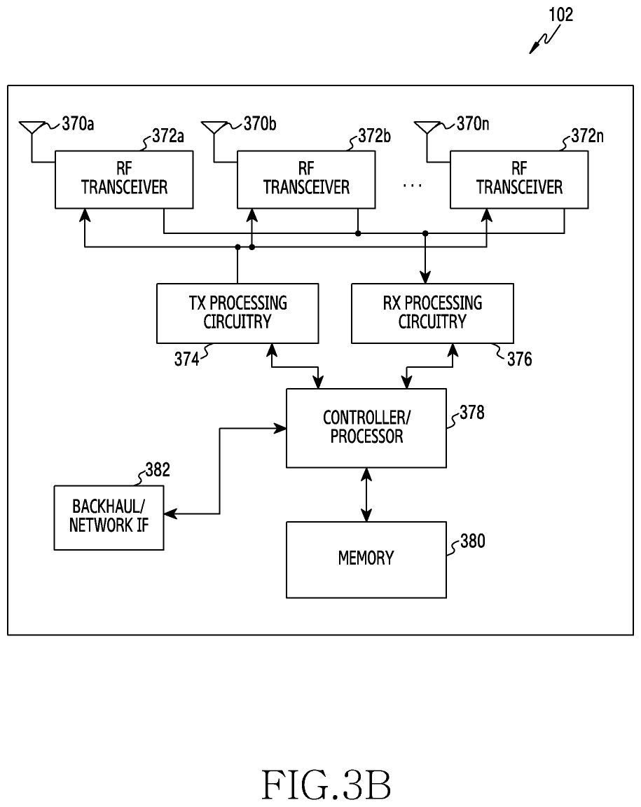

FIGS. 3A and 3B illustrate an example UE and gNB, respectively according to various embodiments of the disclosure.

FIG. 3A illustrates an example UE 116 according to an embodiment of the disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and memory 360. The memory 360 includes a basic operating system (OS) program 361 and one or more applications 362.

The RF transceiver 310 receives, from the antenna 305, an incoming RF signal transmitted by an gNB of the wireless network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 can move data into or out of the memory 360 as required by an executing process. In some embodiments, the main processor 340 is configured to execute the applications 362 based on the basic OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main processor 340.

The main processor 340 is also coupled to the keypad 350 and the display 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to an embodiment of the disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

Referring to FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments, the controller/processor 378 supports communications between entities, such as web real-time communication (RTC). The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 can support communications over any suitable wired or wireless connection(s). For example, when the gNB 102 is implemented as part of a cellular communication system (such as one supporting 5G, LTE, or LTE-A), the backhaul or network interface 382 can allow the gNB 102 to communicate with other gNBs over a wired or wireless backhaul connection. When the gNB 102 is implemented as an access point, the backhaul or network interface 382 can allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102, various changes may be made to FIG. 3B. For example, the gNB 102 can include any number of each component shown in FIG. 3B. As a particular example, an access point can include a number of backhaul or network interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

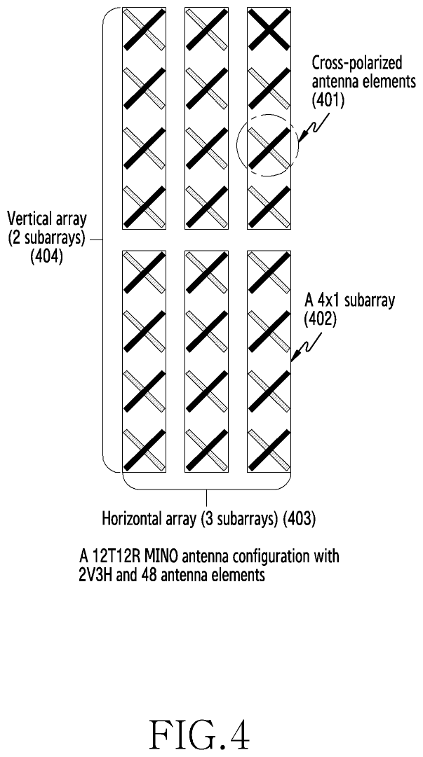

FIG. 4 illustrates a cross-polarized MIMO antenna system according to an embodiment of the disclosure.

Multiple input multiple output (MIMO) system wherein a BS and/or a UE is equipped with multiple antennas has been widely employed in wireless systems for its advantages in terms of spatial multiplexing, diversity gain and array gain. FIG. 4 illustrates an example of MIMO antenna configuration with 48 antenna elements. Referring to FIG. 4, 4 cross-polarized 401 antenna elements form a 4×1 subarray 402. 12 subarrays form a 2V3H MIMO antennas configuration consisting 2 and 3 subarrays in vertical 404 and horizontal 403 dimensions, respectively. Although FIG. 4 illustrates one example of MIMO antenna configuration, the disclosure can be applied to various such configurations.

In MIMO systems, the channel state information (CSI) is required at the base station (BS) so that a signal from the BS is received at the UE with maximum possible received power and minimum possible interference. The acquisition of CSI at the BS can be via a measurement at the BS from an UL reference signal or via a measurement and feedback by the UE from a downlink (DL) reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

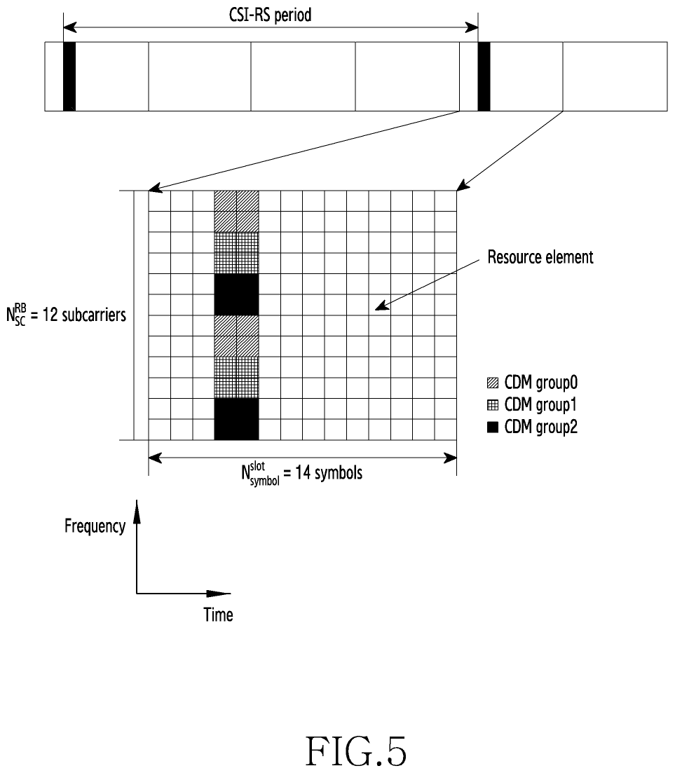

FIG. 5 illustrates a layout for channel state information reference signal (CSI-RS) resource mapping in an orthogonal frequency division multiple access (OFDM) time-frequency grid according to an embodiment of the disclosure.

In some embodiments, a UE may receive a configuration signaling from a BS for a CSI-RS that can be used for channel measurement. An example of such configuration is illustrated in FIG. 5. Referring to FIG. 5, 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations, namely: periodic, semi-persistent and aperiodic are possible. In the figure, an illustrative example of periodic configuration is given with a period of 4 slots.

In some embodiments, the BS is capable of configuring a UE, by a higher layer signaling, with information for a CSI feedback that may include spatial channel information indicator and other supplementary information that would help the BS to have an accurate CSI. The spatial channel indicator, which is reported via a precoding matrix indicator (PMI) in 4G and 5G specifications, comprises a single or a plurality of channel matrix, the channel covariance matrix, the eigenvectors, or spatial sampling basis vectors. In particular, in 4G and 5G specification, the spatial channel information can be given by a single or a plurality of discrete Fourier transform (DFT) basis vectors.

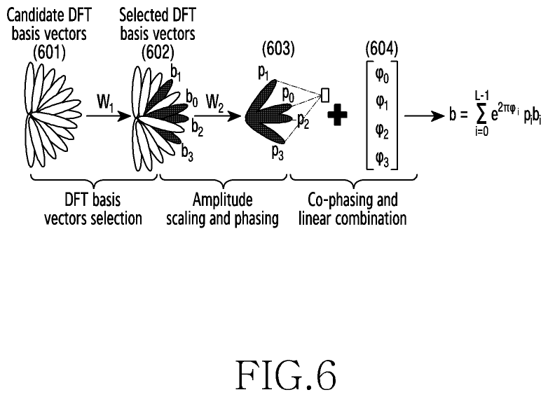

FIG. 6 illustrates an example of precoder construction in Type II CSI according to an embodiment of the disclosure.

FIG. 6 illustrates an example of CSI feedback based on a plurality of DFT basis vectors for what is known as Type II CSI in 5G NR. The spatial information of the channel is reported in terms of L=4 DFT basis vectors {b₀, b₁, b₂, b₃} 602 from a set of candidate DFT basis vectors 601. Additionally, amplitude information {p₀, p₁, p₂, p₃} 603 and co-phasing information {(φ₀, φ₁, φ₂, φ₃} 604 are reported. Thus, in Type II CSI a dual-stage precoding matrix is given as W=W₁W₂, where, W₁ select the DFT basis vectors and W₂ assign amplitude and co-phasing coefficients. Furthermore, a codebook can be defined as superset of candidate DFT basis vectors as well as candidate amplitude and phase coefficients. Then, a reported PMI would consist of indicators to the elements of a codebook that can represent the estimated channel.

In an embodiment, amplitude and phase information are reported in such a way that the linear combination of the basis vectors, i.e.,

$$b = {\sum }_{i = 0}^{L - 1} {e}^{2 π {φ}_{i}} {p}_{i} {b}_{i} ,$$

is matched to the eigenvector direction of the channel. Specifically, for a channel matrix H with the (s, u)-th element h_{s,u} representing the channel gain between the s-th transmit and the u-th receive antenna, the eigenvectors of the covariance matrix H^{H} H can be considered. Let eₗ denote one of the eigenvectors, then the PMI can be selected by the UE in such a way that the value

$$‖ {e}_{l}^{H} b ‖$$

is maximized.

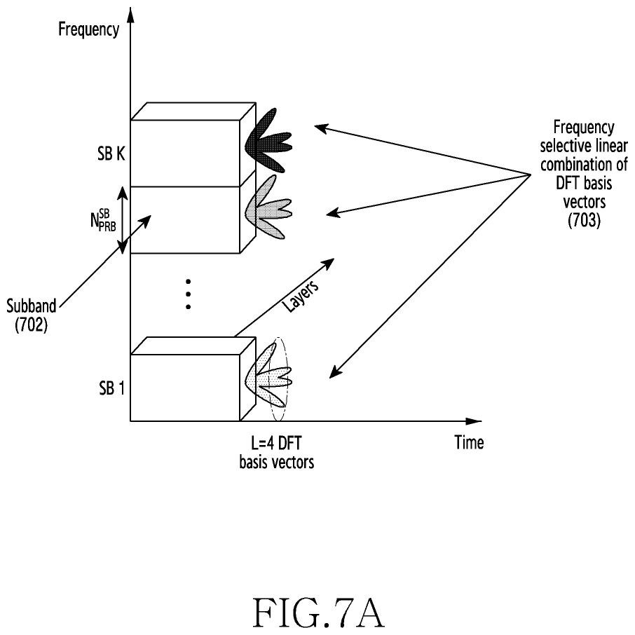

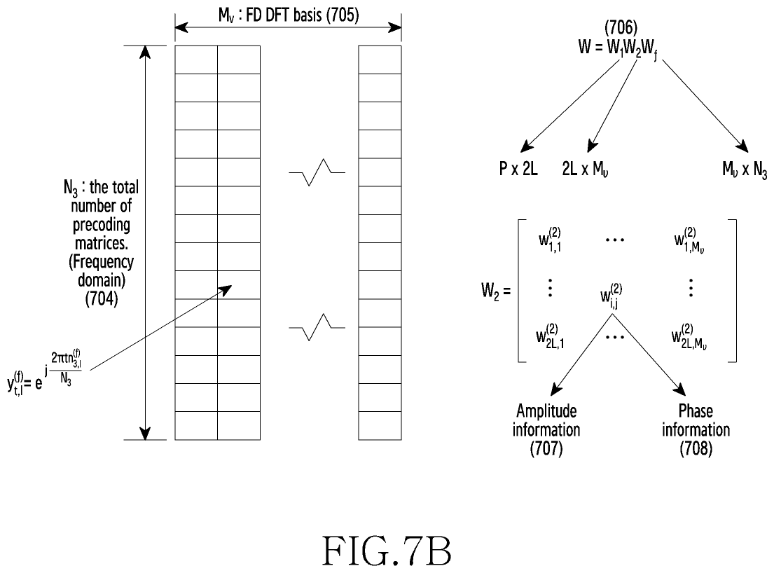

FIG. 7A illustrates reporting precoding matrices in subband granularity according to an embodiment of the disclosure.

FIG. 7B illustrates a precoding matrix construction for enhanced Type II CSI according to an embodiment of the disclosure.

Moreover, a UE can be configured in different ways to report a tuple of DFT basis vectors, amplitude coefficients and the phase coefficients, based on polarization-common or polarization-specific manner. For example, in 5G NR specifications, DFT basis vectors are reported in a polarization-common manner while phase and amplitude coefficients are reported in polarization specific manner, i.e., reported per polarization. MIMO systems allow spatial multiplexing, i.e., transmission of data in multiple transmission layers. In this regard, the type II CSI in the 5G NR allows the DFT basis vectors to be reported in a layer-common manner, i.e., common basis for all layers, while phase and amplitude coefficients to be reported in a layer-specific manner.

In order to account for the frequency-selectivity of a wideband channel, some embodiments allow various components of the precoding matrix, i.e., components of PMI, to be reported per frequency ranges. In some configurations, the frequency band the UE is configured for CSI reporting is partitioned into a set of subbands and the amplitude and/or phases coefficients are reported per a subband manner. In particular, the DL bandwidth part (BWP) can be partitioned in to subbands with subband size

$${N}_{PRB}^{SB}$$

physical resource blocks (PRBs). Then the selected DFT basis vectors are linearly combined with different weights so that the resulting vector is aligned to the eigenvector of the channel in that subband. Denoting the set of subcarriers in the k-th subband as Fₖ, then the eigenvectors of the averaged covariance matrix

$${C}_{k} = \frac{1}{\vert {F}_{k} \vert} = {\sum }_{f ∈ {F}_{k}} ( {( {H}_{f , k} )}^{H} ( {H}_{f , k} ) )$$

can be considered, where, f∈Fₖ are subcarriers in the k-th subband and H_{f,k} is the corresponding channel matrix. FIG. 7A illustrates an example for frequency selective linear combination of DFT basis vectors 703 for K subbands of size

$${N}_{PRB}^{SB}$$

702.

In 5G NR specifications, another configuration, known as enhanced Type II (eType II) CSI, allows reporting amplitude and phase coefficients in a delay-domain rather than per subband reporting in frequency-domain. This configuration reduces the feedback overhead as the delay components are usually much smaller than the equivalent number of subbands. In enhanced Type II codebook (eType II CB) (FIG. 7B), precoding matrices are reported in delay domain by employing frequency-domain (FD) DFT basis rather than the frequency domain reporting in Type II CSI (FIG. 7A), i.e., per subband or wideband. FIG. 7B illustrates construction of eType II CSI. In particular, a precoding matrix is expressed in three-stages

$$W = {W}_{1} {W}_{2} {W}_{f}^{H}$$

706. The spatial domain selection matrix W₁ selects L DFT vectors from P=2N₁N₂ CSI-RS ports, consequently, it has 2L rows accounting for the cross-polarized antennas. Moreover, an M_{υ}×N₃ matrix

$${W}_{f}^{H}$$

corresponds to M_{υ} DFT basis vectors 705 that can transform the precoding matrix reported in delay domain for M_{υ} delay components to a frequency domain with N₃ frequency domain points (bins) 704. In particular, the t∈{1,2, . . . , N₃}-th element of f-th vector is given by

$${y}_{t , l}^{( f )} = {e}^{\frac{j 2 π {tn}_{3 , l}^{( f )}}{{N}_{3}}} .$$

Finally, the matrix W₂ carries the amplitude and phase information wherein the i-th and j-th element, w_{i,j}, carries amplitude 707 and phase 708 information of i-th 2D DFT beam and j-th delay component.

In order to further reduce the CSI overhead, a system may exploit angle-delay reciprocity and measure the dominant angle and delay components of a channel from an UL reference signal such as sounding reference signal (SRS). Then, a precoded CSI-RS can be considered for DL CSI measurement wherein the CSI-RS ports are mapped to an angle-delay component of the channel. Moreover, delay pre-compensation can be applied to the CSI ports so that the UE would measure CSI for a fewer number of delay components, i.e., in the extreme case for just one delay component.

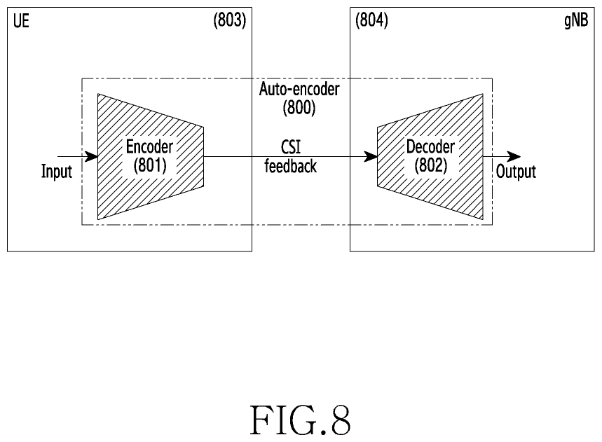

FIG. 8 illustrates an autoencoder based CSI feedback according to an embodiment of the disclosure.

Recently, artificial intelligence (AI)-based CSI feedback has gained considerable attention. In particular, an auto-encoder (AE) 800, as depicted in FIG. 8, consisting of an encoder part 801 at the UE 803 generates the CSI feedback and a decoder 802 at the gNB 804 reconstructs the CSI feedback. The main aim of an AE-based CSI feedback is to find the best representation of a channel state information in terms of feedback overhead. In another words, AE compresses the CSI to reduce the CSI feedback overhead.

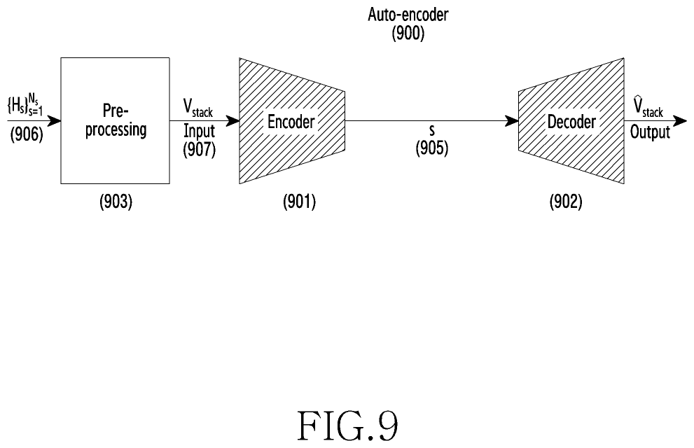

FIG. 9 depicts an embodiment for an autoencoder based CSI feedback wherein a preprocessing unit transforms the estimated channel to stacked eigenvectors according to an embodiment of the disclosure.

The input for an autoencoder can take different formats. In one embodiment, the input can be the eigenvectors of the channel. The covariance matrix of an Nₜ×Nᵣ channel matrix H given as H^{H} H can be computed by the UE. Then, the dominant eigenvectors of the covariance matrix svd(H^{H} H)=VΣA given as V=[υ₁ . . . υᵣ] can be considered as an input for the autoencoder 900. An illustration of such embodiment is given in FIG. 9. A set of Ns channel matrices which belong to Nₛ subbands, i.e.,

$${\{ {H}_{s} \}}_{s = 1}^{{N}_{s}} ,$$

is input 906 for a pre-processing unit in 903. The preprocessing unit compute the Ns eigenvectors and stack them as a column of a matrix V_{stack} 907. An encoder 901 is then generates a CSI feedback in terms of a bit stream s 905. The decoder 902 part of the autoencoder, takes the CSI feedback and reconstructs the stacked eigenvectors. Moreover, a gNB then may use the reconstructed stacked eigenvectors \hat{V}_{stack} as precoders.

### References

[1] RP-193133, New WID: Further enhancements on MIMO for NR,

Samsung
[2] 3GPP TS 38.213, V15.12.0 (2020-12): “NR; Physical layer procedures for control (Release 15)”,
[3] 3GPP TS 38.214, V15.11.0 (2020-09): “NR; Physical layer procedures for data (Release 15)”,
[4] 3GPP TS 38.213, V16.4.0 (2020-12): “NR; Physical layer procedures for control (Release 16)”
[5] 3GPP TS 38.214, V16.4.0 (2020-12): “NR; Physical layer procedures for data (Release 16)”,
[6] 3GPP TS 38.321, V16.3.0 (2020-12): “NR; Medium Access Control (MAC) protocol specification (Release 16)”,
[7] 3GPP TS 38.331, V16.3.1 (2021-01): “NR; Radio Resource Control (RRC) protocol specification
[8] 3GPP TS 38.211, V16.4.0 (2020-12): “NR; Physical channels and modulation.”
[9] 3GPP TS 38.212, V16.4.0 (2020-12): “NR; Multiplexing and channel coding.”
[10] 3GPP TS 38.215, V16.4.0 (2020-12): “NR; Physical layer measurements”

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the disclosure and various changes could be made to the methods illustrated in the flowcharts herein. For example, while shown as a series of operations, various operations in each figure could overlap, occur in parallel, occur in a different order, or occur multiple times. In another example, operations may be omitted or replaced by other operations.

Distributed MIMO, also known as a Multi-TRP (mTRP) transmission scheme, in which a particular UE is served by multiple geographically distributed TRPs has several performance benefits. The geographically dispersed TRPs offer extensive channel diversity, which subsequently leads to higher throughput perceived by the system and UEs, improved interference management, and smoother handovers. The 5G NR framework supports two mTRP schemes, namely non-coherent joint transmission (NCJT) and joint coherent transmission (CJT). In particular, the network acquires through UE's CSI measurements and feedbacks as well as sounding reference signal (SRS)-based measurements at the TRPs, with the latter being pertinent to TDD systems that assume channel reciprocity.

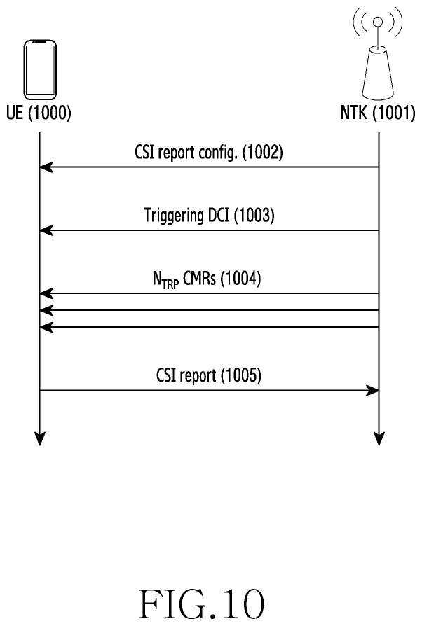

FIG. 10 illustrates a procedure for mTRP CSI reporting according to an embodiment of the disclosure.

For UE's measurement on CSI-RS and CSI feedback, the network may configure the UE with a set of TRPs as a measurement set for CSI measurement. In this regard, a channel measurement resource (CMR), e.g., as a CSI-RS resource, or port group, can be assumed to be mapped to a TRP.

In some configurations, as illustrated in FIG. 10, the UE 1000 may be configured 1002 to measure N_{TRP} TRPs by network 1001. UE can receive triggering downlink control information (DCI) for the measurement 1003. The configuration can be given to the UE with N_{TRP} channel measurement resources (CMRs) 1004, i.e., implying CSI measurements from a TRP corresponds to a CMR. Additionally, the UE may be configured to report CSI feedback including rank indication (RI), precoding matrix information (PMI) and channel quality indication (CQI). The configuration 1002 may indicate for the UE the mTRP transmission scheme, at least one of CJT and NCJT, to determine the CSI. This configuration can be conveyed via a codebook configuration. The UE may then report a CSI feedback 1005, including precoding information corresponding to the configured TRPs. Particularly, the precoding matrix per each layer can be represented as=[W₁^{T} . . . . W_{N}_{_{TRP}}^{T}]^{T}.

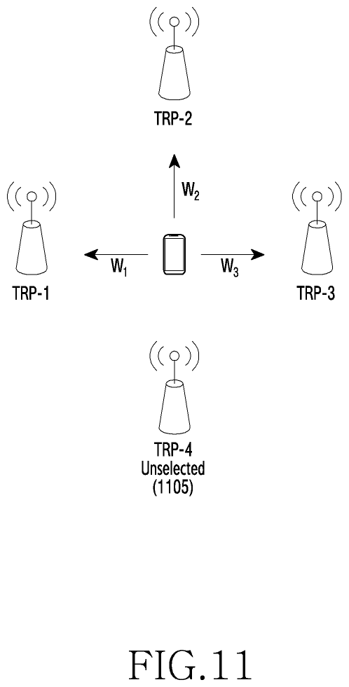

FIG. 11 illustrates dynamic CMR or TRP selection in mTRP CSI reporting according to an embodiment of the disclosure.

In some cases, it is beneficial if the UE dynamically selects the TRPs it prefers to be transmitted from. To achieve this, the network may configure the UE whether dynamic TRP selection is possible or not. The configuration may be indicated by a higher layer parameter, e.g., as specified in Rel-18 NR by a higher layer parameter ‘restrictedCMR-selection’. Thus, if dynamic TRP, vis-à-vis CMR, selection is allowed, the UE prepares CSI, including at least one of RI, PMI, and CQI, corresponding to N≤N_{TRP} TRPs. As an example, the PMI indicate a mTRP precoder can be represented as W=[W₁^{T} . . . W_{N}^{T}]^{T}. Conversely, the UE determines the CQI considering the selected TRPs and the determined PMI. In this regard, the channel corresponding to the unselected TRP, as illustrated by 1105 of FIG. 11, may not be part of the CSI feedback reporting.

The absence of the CSI corresponding to the unselected TRPs in the CSI report, impacts the system performance. For example, if other UEs are scheduled, in the same time-frequency resources as the referred UE for multi-user (MU) scheduling by the transmission from the unselected TRPs, these transmissions incur interference on the referred UE. If the channel information for the unselected TRPs, e.g., 1105, are reported to the network, the network may utilize the information for MU scheduling, interference management, as transmission alternatives and other purposes. In the following, methods and apparatus to overcome this limitation are introduces.

### Configuration Aspects

As one aspect of this disclosure, in Method I, the network configures the UE to report CSI for two hypotheses. The first hypothesis corresponds to the TRPs the UE prefers to be transmitted from, henceforth, named as transmission hypothesis. The second hypotheses corresponds to the TRPs that do not correspond to the first hypothesis. Since the TRP in the second hypotheses may incur interference, in the subsequent clauses the second hypothesis is referred as interference hypothesis.

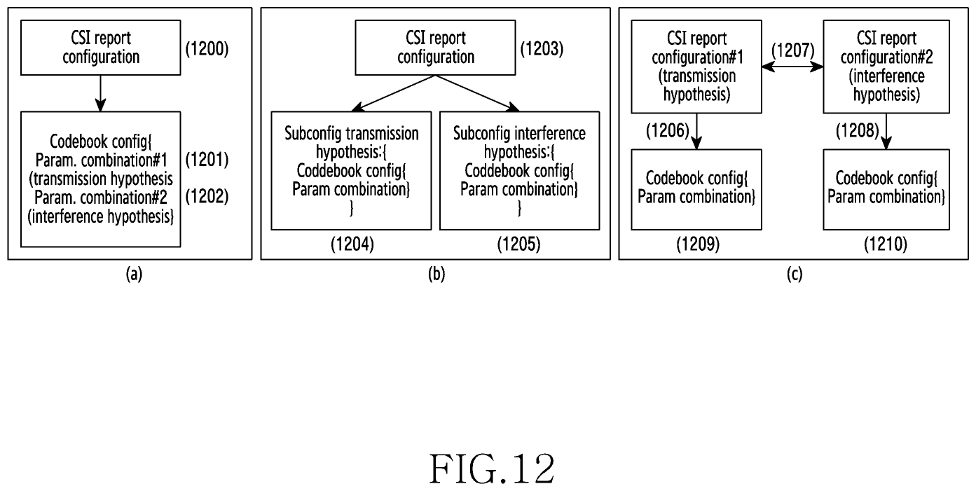

FIG. 12 illustrates a higher layer configuration for CSI reporting corresponding to two CSI reporting hypotheses according to an embodiment of the disclosure.

As a yet another aspect of this disclosure, the configuration for CSI report corresponding to the two hypotheses, i.e., transmission hypothesis and interference hypothesis, are given in at least three different ways. This is illustrated in FIG. 12.

Referring to part (a) of FIG. 12, the network configures the UE with a CSI report configuration 1200 wherein the CSI configuration may consist of codebook configuration. The codebook configuration, in turn, consists of two higher layer parameters for codebook parameter combinations, e.g., number of SD basis vectors (L), implicit or explicit indicator for number of FD basis vectors (ρᵥ), the number of PMI reporting per CQI bands (R), the ratio or the number of non-zero components to (β), the feedback size per layer or across layer, e.g., M. The first parameter combination 1201 and the second parameter combination 1202 correspond to the first and second CSI reporting hypothesis, respectively.

In a yet another aspect of this disclosure, the CSI report configuration 1203 consists of the two sub-configurations, wherein the first sub-configuration 1204 and second sub-configuration 1205 consist of codebook configurations and the corresponding parameter combinations for the first (transmission) and second (interference) hypotheses.

In a yet another aspect, the network configures the UE with two linked CSI report configurations, wherein the first report configuration 1206 and second report configuration 1208, each may consisting of the codebook configurations e.g., first codebook configuration 1209 and a second codebook configuration 1210, while the first and second report configurations correspond to first (transmission) and second (interference) hypotheses. In one consideration, the two CSI reporting configurations 1206 and 1208 can be linked 1207 by a triggering DCI which indicates the both reporting configurations. In a yet another consideration, the two CSI report configurations can be linked by a higher layer parameter in the first report configuration which indicates the CSI report configuration ID for the first CSI report configuration.

In most cases, the CSI reporting resolution for the first (transmission) hypothesis and second (interference) hypothesis do not have the same. It is beneficial if the uplink CSI carrying resources are efficiently used by reporting CSI in higher resolution for the first reporting hypothesis than the second. In one aspect of this disclosure, the network may configure the UE with two frequency domain granularities, e.g., two configuration parameters for subband sizes, for the two reporting hypotheses. As one specific case of this aspect, the network may configure the UE with frequency domain granularity for the second CSI hypothesis in relation to the frequency granularity configuration for the first hypothesis, e.g., the second as the integral multiple of the first one.

In a yet another aspect of this disclosure, the network may configure the UE with two time domain granularities, e.g., two configuration parameters for subtime sizes, each parameter corresponding to each the two reporting hypotheses. As one specific case of this aspect, the network may configure the UE with the time domain granularity for the second CSI hypothesis in relation to the time domain granularity configuration for the first hypothesis, e.g., the second as the integral multiple of the first one.

### Reporting Aspects

As one aspect of this disclosure, in Method II, when the network configures the UE to report CSI for two hypotheses, first one for the transmission hypothesis and the second hypothesis corresponding to the interference hypothesis, the network additionally configures the UE with the conditions based on which the UE reports the CSI for the interference hypothesis.

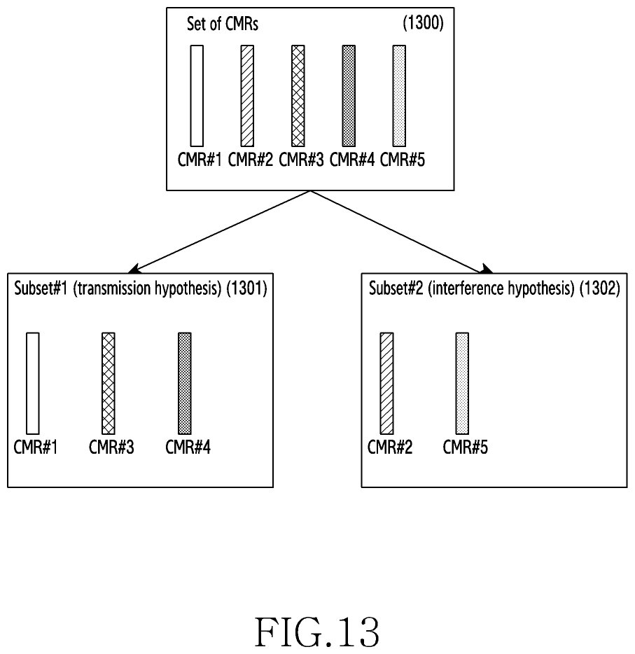

FIG. 13 illustrates two CMR subsets each subset corresponding to one of the two CSI reporting hypotheses, wherein the CMR subsets are formed from configured CMR set according to an embodiment of the disclosure.

Referring to FIG. 13, according to this disclosure, upon the reception of configuration information according to Method I, the UE first forms two subsets of CMRs 1301 and 1302 for the first and second hypothesis, from a set of CMRs 1300. The UE then determines the reported CSI for the first and second hypothesis based on the first and second CMR subsets, respectively.

As a yet another aspect of this disclosure, in Method II.1, the network configures the UE to report CSI corresponding for two reporting hypothesis, the configuration information includes the condition for the UE to determine the CMRs in the subset of CMRs corresponding to the second (interference) hypothesis. The condition includes reference signal received power (RSRP), reference signal received quality (RSRQ), CQI difference between a CMR in the CMR subset for the first hypothesis 1301 and a CMR in CMR subset for the second hypothesis.

As an embodiment of Method II.1, the network configures the UE with a threshold, e.g., th_{RSRP}. The threshold can be considered either absolute value or relative value as compared to the RSRP value of another CMR.

In accordance to one aspect of this disclosure, when the UE is configured with the threshold e.g., th_{RSRP}, it includes the CMRs with corresponding RSRP value higher than the configured threshold and which are not in the CMR subset for first hypothesis to the CMR subset for the second hypothesis.

In accordance to one aspect of this disclosure, when the UE is configured with the threshold e.g., th_{RSRP}, it includes the CMRs which are not in the first CMR subset and with corresponding RSRP value within the configured threshold as compared to the RSRP value of a particular CMR in the first CMR subset. The particular CMR in first CMR subset can be the CMR with highest or lowest RSRP among the CMRs in the first CMR subsets.

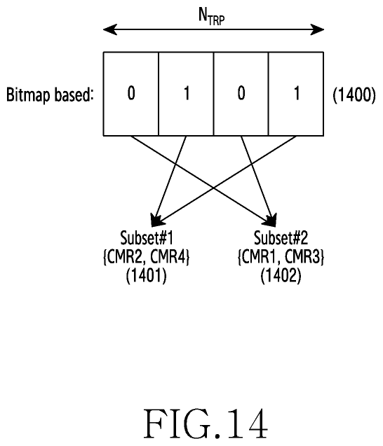

FIG. 14 illustrates a single bitmap based indication for the CMRs in the two CMR subsets according to an embodiment of the disclosure.

In accordance to one aspect of this disclosure, the UE is configured with a CSI report configuration wherein the CSI report configuration refers to NTRP CMRs, among the these CMRs the UE may select and report N≤N_{TRP} for the first CMR subset and M=N_{TRP}−N CMR for the second hypothesis. The UE indicates the CMRs in the two CMR subsets by using a single bitmap vector 1400 with length N_{TRP} as illustrated in FIG. 14. The first bit of the bitmap corresponds the first CMR, second bit corresponds the second CMR, and so on. The CMRs corresponding to the reported bit value of ‘1’ 1401 correspond to the first CMR subset, i.e., first CSI reporting hypothesis. The CMRs corresponding to the reported bit value of ‘0’ 1402 correspond to the second CMR subset, i.e., second CSI reporting hypothesis.

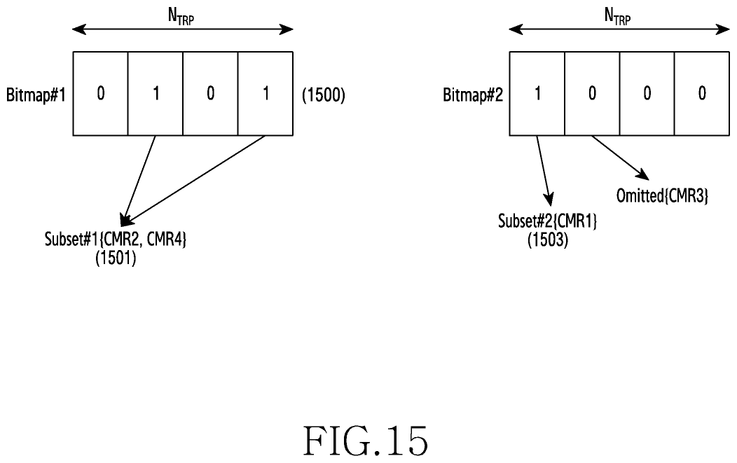

FIG. 15 illustrates two bitmaps based indication for the CMRs in the two CMR subsets according to an embodiment of the disclosure.

In accordance to a yet another aspect of this disclosure, the UE is configured with a CSI report configuration wherein the CSI report configuration refers to N_{TRP} CMRs, among these CMRs the UE may select and report N≤N_{TRP} for the first CMR subset and M≤N_{TRP}−N CMR for the second hypothesis. If N+M<N_{TRP}, N_{TRP}−(N+M) CMRs are not considered in either of the CSI reporting hypotheses. In this case, the UE indicates the CMRs in the two CMR subsets by using two bitmap vectors of length N_{TRP} as illustrated in FIG. 15. The first bits of the two bitmaps corresponds the first CMR, second bit corresponds the second CMR, and so on. The CMRs corresponding to a bit value of ‘1’ in the first bitmap 1500 belong to the first CMR subset 1501, i.e., first CSI reporting hypothesis. The CMRs corresponding to a bit value of ‘1’ in the second bitmap 1502 belong to the second CMR subset 1503, i.e., second CSI reporting hypothesis.

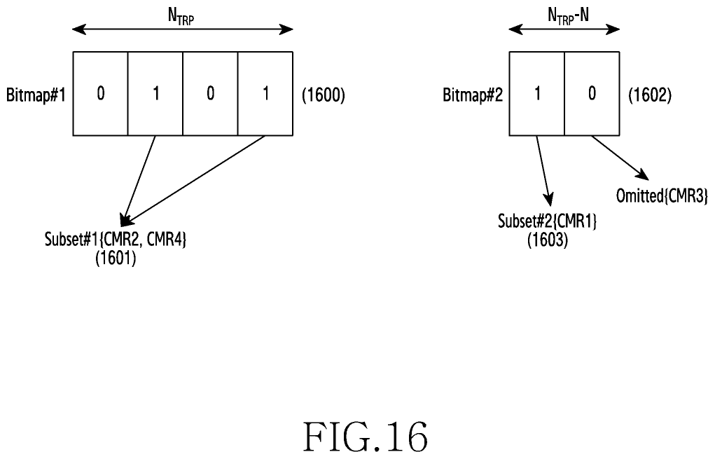

FIG. 16 illustrates two bitmaps based indication for the CMRs in the two CMR subsets wherein the second bitmap has a variable size depending on the indication in the first bitmap according to an embodiment of the disclosure.

For the embodiment in FIG. 15, the total number of bits required for the indication can be reduced if the length of the second bitmap scales with the number of CMRs which are not indicated in the first bitmap. In accordance to a yet another aspect of this disclosure, when the UE is configured with a CSI report configuration wherein the CSI report configuration refers to N_{TRP} CMRs, among these CMRs, the UE may select and report N≤N_{TRP} CMRs for the first CMR subset and M≤N_{TRP}−N CMRs for the second hypothesis. If N+M<N_{TRP}, then N_{TRP}−(N+M) CMRs are not considered in the CSI feedback for either of the CSI reporting hypotheses. In this case, the UE indicates the CMRs in the two CMR subsets by using two bitmap vectors where the first with length N_{TRP} and the second with length N_{TRP}−N as illustrated in FIG. 16. From the MSB to LSB of the bitmap vectors, the first bits of the first bitmap vector corresponds to the first CMR, and second bit corresponds the second CMR, and so on. The first bit of the second bitmap vector corresponds to the CMR which corresponds to the first bit with a bit value of ‘0’ in the first bitmap, the second bit of the second bitmap vector corresponds to the CMR which corresponds to the second bit with a bit value of ‘0’ in the first bitmap, and so on. The CMRs corresponding to a bit value of ‘1’ in the first bitmap 1600 belong to the first CMR subset 1601, i.e., first CSI reporting hypothesis. The CMRs corresponding to a bit value of ‘1’ in the second bitmap 1602 belong to the second CMR subset 1603, i.e., second CSI reporting hypothesis.

### Reporting Quantities

The reporting quantity for the two CSI reporting hypotheses can be indicated with one parameter or two separate parameters.

In some cases, in order to manage interference, it may be sufficient for the network to receive the precoding vectors for the CMRs (TRPs) corresponding to the second CSI reporting hypothesis. In an embodiment, the network configures the UE with a single CSI reporting quantity in the CSI reporting configuration. The CSI reporting quantity may configure the UE to report at least one of CSI-RS resource indicator (cri), RI, PMI, CQI or LI. Upon reception of such configuration, the UE reports the configured quantities for the first CSI reporting hypothesis. If the UE is configured to report CSI for two reporting hypotheses and if ‘PMI’ is a part of the configured reporting quantities, the UE reports PMI for the second CSI reporting. The UE is not expected to report other quantities to the network for the second hypothesis.

In some cases, in order to manage interference, it may be sufficient for the network to receive the precoding vectors for the CMRs (TRPs) corresponding to the second CSI reporting hypothesis. If the UE reports for the interference channel based on precoding vectors, it is important for the precoding vectors to be calculated based on the same spatial filter as the one to be used for transmission based on the reported CSI for the transmission hypothesis. This give accurate information for the network on the level of interference when the UE received downlink transmission based on the reported CSI for the transmission hypotheses.

In an embodiment, when the UE is configured to report CSI for two reporting hypotheses, according to Method I, the network configures the UE with a single CSI reporting quantity in the CSI reporting configuration. The CSI reporting quantity may configure the UE to report at least one of cri, RI, PMI, CQI or LI.

Upon reception of such configuration, the UE reports the configured quantities for the first CSI reporting hypothesis.

The reporting quantity can be configured in the CSI in the shared reporting configuration information element as in 1200, in the sub-configuration for the first hypothesis 1204, or CSI report configuration for the first hypothesis 1206.

If ‘PMI’ is a part of the configured reporting quantities, the UE reports PMI per each of the reported CMR in the second CMR subset for the second CSI reporting hypothesis.

The UE calculates PMI for the M precoding vectors of PMI reporting time-frequency unit that corresponding to the M CMRs reported in second CMR subset assuming the same receive spatial filter as for the preferred receive filter for the downlink transmission based on the reported CSI for the first CSI hypothesis.

In some cases, in order to manage interference, it may be sufficient for the network to receive the interference level from CMRs corresponding to the second CSI reporting hypothesis. In this case, the interference level can be indicated by CSI reporting quantities such RSRP.

In an embodiment, when the UE is configured to report CSI for two reporting hypotheses according to Method I, the network configures the UE with a single CSI reporting quantity in the CSI reporting configuration. The CSI reporting quantity may configure the UE to report at least one or more of cri, RI, PMI, CQI.

Upon reception of such configuration, the UE reports the configured quantities for the first CSI reporting hypothesis.

According to the configuration methods described in the previous clauses, the reporting quantity can be configured in the shared reporting configuration information element as in 1200, in the sub-configuration for the first hypothesis 1204, or CSI report configuration for the first hypothesis 1206.

The UE reports the interference level with predefined rule, e.g., a single bit per CMR in the second CMR, to indicate whether the interference level from the CMR is high or low.

In an embodiment, when the UE is configured to report CSI for two reporting hypothesis according to Method I, the network configures the UE with a single CSI reporting quantity in the CSI reporting configuration. The CSI reporting quantity may configure the UE to report at least one or more of cri, RI, PMI, CQI.

Upon reception of such configuration, the UE reports the configured quantities for the first CSI reporting hypothesis.

According to the configuration methods described in the previous clauses, the reporting quantity can be configured in the shared reporting configuration information element as in 1200, in the sub-configuration for the first hypothesis 1204, or CSI report configuration for the first hypothesis 1206.

The UE reports the interference level with predefined rule with M RSRP values per RSRP reporting time-frequency unit for the M CMRs in the second CSI reporting hypothesis.

The UE calculates the RSRP assuming the same receive spatial filter as for the preferred receive filter for the downlink transmission based on the reported CSI for the first CSI hypothesis.

In some cases it is beneficial if the UE reports the explicit channel matrix for the two hypothesis. This allows the network to calculate a precoding vector for any subset of the CMRs in the two hypothesis for downlink transmission while managing interference according to its MU scheduling. In this case, the UE may report the explicit channel information according to the configuration.

In one another consideration, when the UE is configured to report CSI for two reporting hypothesis according to Method I, the network may configure the UE with two parameters for the CSI reporting quantities configurations. The CSI reporting quantity may configure the UE to report at least explicit channel information.

Upon reception of such configuration, the UE reports the configured quantities for the first CSI reporting hypothesis including N+M explicit channel information corresponding to the CMRs reported for the two CSI reporting hypothesis.

According to the configuration methods described in the previous clauses, the reporting quantity can be configured in the shared reporting configuration information element as in 1200, in the sub-configuration for the first hypothesis 1204, or CSI report configuration for the first hypothesis 1206.

In an embodiment, when the UE is configured to report CSI for two reporting hypothesis according to Method I, the network configures the UE with a single CSI reporting quantity in the CSI reporting configuration. The CSI reporting quantity may configure the UE to report at least one or more of cri, RI, PMI, CQI, interference level indication, RSRP values, explicit channel information, etc. Upon reception of such configuration, the UE reports the configured quantities for the first CSI reporting hypothesis according to the first configured parameter for CSI reporting quantities.

The UE reports the configured quantities for the second CSI reporting hypothesis according to the second configured parameter for CSI reporting quantities.

According to the configuration methods described in the previous clauses, the two parameters for reporting quantity can be configured in the shared reporting configuration information element as in 1200, in the two sub-configurations 1204, or CSI report configuration for the first hypothesis 1206.

### UCI Construction and Reporting Priorities

When the CSI report is subject to partial dropping, the UCI construction and priority rule is important to decide which part of the report to be transmitted or dropped. When the UE is reporting the CSI for the first and the second hypothesis the UE may reconstruct the uplink control information according to a predefined rule.

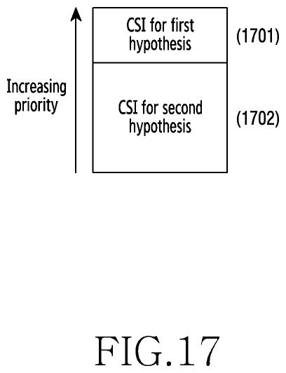

FIG. 17 illustrates UCI construction aspects for CSI reporting corresponding to two CSI reporting hypothesis according to an embodiment of the disclosure.

In an embodiment, when the UE is configured to report CSI for two reporting hypothesis, and when the UE reports the CSI in two parts.

The UE constructs the first part of CSI 1701 based on the reporting components of the two CSI reporting hypothesis to be reported in the first part.

The UE constructs the second part of CSI 1702 based on the reporting components of the two CSI reporting hypothesis to be reported in the second part.

If the uplink resources to carry the CSI report is not sufficient, the UE drops the CSI components according to their priority levels first from the second part and then from the first part. The CSI components for the second CSI reporting hypothesis takes lower priority than the CSI components for the first reporting hypothesis.

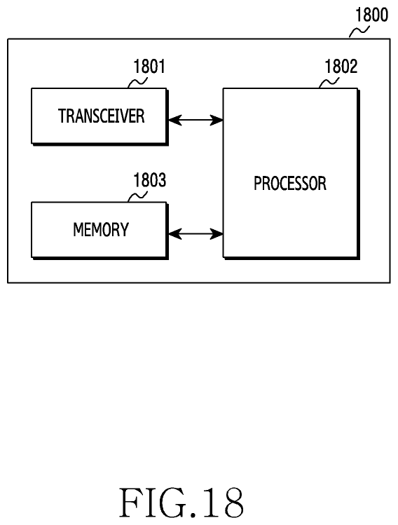

FIG. 18 is a block diagram of a terminal or user equipment (UE) 1800 according to an embodiment of the disclosure. The UE of FIG. 18 corresponds to the UE of FIG. 3A.

The terminal is an electronic device capable of wireless communication, may include a User Equipment (UE), a portable phone, a smartphone, a tablet, an Internet of things (IoT) device, etc., having various form factors, and may perform wireless communication with a base station (BS) through a wireless channel.

Referring to FIG. 18, the UE 1800 may include at least one transceiver (hereinafter, referred to as simply “transceiver”) 1801, at least one processor (hereinafter, referred to as simply “processor”) 1802, and at least one memory (hereinafter, referred to as simply “memory”) 1803. According to at least one or a combination of methods corresponding to the embodiments described in the disclosure, the transceiver 1801, the processor 1802, and the memory 1803 of the UE 1800 may operate. However, components of the UE 1800 are not limited to the components illustrated in FIG. 18. In another embodiment, the UE 1800 may further include additional components in addition to the above-mentioned components, or some components may be omitted. Further, in some embodiments, any combination of the transceiver 1801, the processor 1802, or the memory 1803 may be integrated in the form of one component.

The transceiver 1801 may be a communication circuit or communication circuitry that enables the UE 1800 to perform wireless communication with a node or an entity of a network. For example, the transceiver 1801 may enable the UE 1800 to transmit or receive a signal to or from a BS through cellular communication, or to transmit or receive a signal to or from another UE through cellular communication. For example, the transceiver 1801 may support at least one of various cellular communication technologies including 3rd generation (3G), 4th generation (4G), long term evolution (LTE), 5th generation (5G) NR, 6th generation (6G), and various cellular wireless communication technologies supported by the transceiver 1801 may include all subsequent generations of evolved wireless communications.

According to an embodiment, the UE 1800 may include a plurality of transceivers. For example, in the case of supporting evolved-universal terrestrial radio access-new radio (E-UTRA-NR) dual connectivity (EN-DC), the UE 1800 may include a first transceiver supporting the 4G LTE wireless communication and a second transceiver supporting the 5G NR wireless communication. According to another embodiment, in the case of supporting NR-dual connectivity (NR-DC), the UE 1800 may include a plurality of transceivers supporting the 5G NR wireless communication. According to still another embodiment, in the case of supporting near field wireless communication, the UE 1800 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 1801 may include various circuit structures used to transmit or receive signals to or from a BS through a wireless channel. The signals may include control information and data. For example, the transceiver 1801 may include a radio frequency (RF) transmitter for up-converting and amplifying the frequency of a transmitted signal and an RF receiver for low-noise-amplifying a received signal and down-converting the frequency thereof. The transceiver 1801 may output a signal received through a wireless channel to the processor 1802 and may transmit, through a wireless channel, a signal output from the processor 1802.

The processor 1802 may control general operations of the UE 1800 according to embodiments of the disclosure. The processor 1802 may be implemented by one or more integrated circuit (or circuitry) (IC) chips and may execute various data processings. The processor 1802 may include at least one electric circuit, and may execute instructions (or a program, codes, data, etc.) stored in the memory 1803, individually, collectively or in any combination thereof. Further, the processor 1802 may include a single-core processor or multi-core processor, and may include a processor assembly including a plurality of processing circuits (circuitry) according to a specific implementation scheme.

The processor 1802 may be electrically, operatively, or communicatively coupled to the transceiver 1801 to control the transceiver 1801.

The processor 1802 may include at least one processor (or processing circuitry), and the at least one processor may perform the following operations individually, collectively or in any combination thereof. For example, the processor 1802 may include a communication processor (CP) configured to control communication operations and an application processor (AP) configured to control execution of an upper layer (for example, an application layer). In a specific embodiment, at least a part of the processor 1802 may be included in one chip and the other part of the processor 1802 may be included in another chip. Otherwise, at least one processor may be included in another component, for example, the transceiver 1801 or the memory 1803.

The processor 1802 may perform or control or cause an operation of the UE 1800 for executing at least one or a combination of methods according to embodiments of the disclosure. For example, the processor 1802 may control operations of the UE 1800 for processing a downlink signal received from a BS or generating and transmitting an uplink signal to a BS. To this end, the processor 1802 may execute a computer program, codes, or instructions stored in the memory 1803, so as to control other components of the UE 1800 to enable execution of various operations.

The memory 1803 corresponds to a hardware storage device capable of temporarily or permanently storing information and may include one or more storage media. For example, the memory 1803 may include memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1803 may be electrically, operatively, or communicatively coupled to the processor 1802 and may be accessed by the processor 1802.

The memory 1803 may store a computer program, codes, or instructions executable by the processor 1802. According to an embodiment, a computer program, codes, or instructions executable by the processor 1802 may be either stored in a single memory device or separated and distributedly stored in two or more memory devices. By executing the instructions stored in the memory 1803, the processor 1802 may perform various functions according to an embodiment of the disclosure.

According to an embodiment of the disclosure, operations of the UE 1800 may be caused to be performed based on execution of instructions (or a computer program or codes) stored in the memory 1803 by at least one processor (or processing circuitry) configured to execute the same individually, collectively, or in any combination thereof, based on processing circuitry that is not configured to execute instructions, and/or based on components of processing circuitry that is not configured to execute instructions.

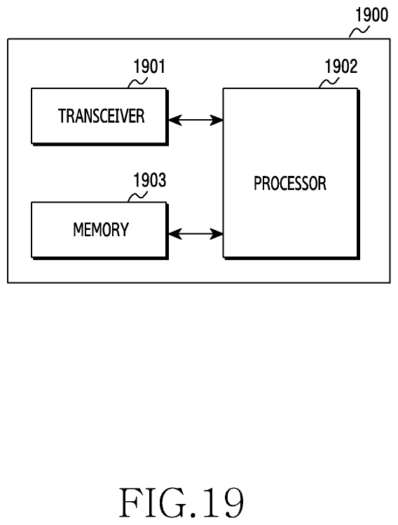

FIG. 19 is a block diagram of a base station (BS) 1900 according to an embodiment of the disclosure. The base station of FIG. 19 corresponds to the base station of FIG. 3B.

The BS 1900 may perform wireless communication with at least one user equipment (UE) located within the area of the BS 1900 through a wireless channel.

Referring to FIG. 19, the BS 1900 may include at least one transceiver (hereinafter, referred to as simply “transceiver”) 1901, at least one processor (hereinafter, referred to as simply “processor”) 1902, and at least one memory (hereinafter, referred to as simply “memory”) 1903. According to at least one or a combination of methods corresponding to the embodiments described in the disclosure, the transceiver 1901, the processor 1902, and the memory 1903 of the BS 1900 may operate. However, components of the BS 1900 are not limited to the components illustrated in FIG. 19. In another embodiment, the BS 1900 may further include additional components in addition to the above-mentioned components, or some components may be omitted. Further, in some embodiments, any combination of the transceiver 1901, the processor 1902, or the memory 1903 may be integrated in the form of one component.

The transceiver 1901 may be a communication circuit or communication circuitry that enables the BS 1900 to perform wireless communication with a node or an entity of a network. For example, the transceiver 1901 may enable the BS 1900 to transmit or receive a signal to or from the UE X00 through cellular communication, or to transmit or receive a signal to or from another network entity through wireless communication. For example, the transceiver 1901 may support various cellular communication technologies including 3rd generation (3G), 4th generation (4G), long term evolution (LTE), 5th generation (5G) NR, 6th generation (6G), and various cellular wireless communication technologies supported by the transceiver (1901) may include all subsequent generations of evolved wireless communications. According to an embodiment, the transceiver 1901 may include various circuit structures used to transmit or receive signals to or from a UE through a wireless channel. The signals may include control information and data. For example, the transceiver 1901 may include a radio frequency (RF) transmitter for up-converting and amplifying the frequency of a transmitted signal and an RF receiver for low-noise-amplifying a received signal and down-converting the frequency thereof. The transceiver 1901 may output a signal received through a wireless channel to the processor 1902 and may transmit, through a wireless channel, a signal output from the processor 1902.

Meanwhile, according to an embodiment of the disclosure, the BS 1900 may perform communication with a node or an entity of a network through wired or wireless communication. For example, the BS 1900 may perform wired or wireless communication with an adjacent BS, or a node or an entity of a core network through a backhaul network. Although not illustrated in FIG. 19, when the BS 1900 performs wired communication, the BS 1900 may further include a separate network interface for wired communication in addition to the transceiver 1901. The network interface may be referred to as network interface circuitry or communication interface circuitry.

The processor 1902 may control general operations of the BS 1900 according to embodiments of the disclosure. The processor 1902 may be implemented by one or more integrated circuit (or circuitry) (IC) chips and may execute various data processings. The processor 1902 may include at least one electric circuit, and may execute instructions (or a program, codes, data, etc.) stored in the memory 1903, individually, collectively or in any combination thereof. Further, the processor 1902 may include a single-core processor or multi-core processor, and may include a processor assembly including a plurality of processing circuits (circuitry) according to a specific implementation scheme.

The processor 1902 may be electrically, operatively, or communicatively coupled to the transceiver 1901 to control the transceiver 1901.

The processor 1902 may include at least one processor (or processing circuitry), and the at least one processor may perform the following operations individually, collectively or in any combination thereof. In a specific embodiment, at least a part of the processor 1902 may be included in one chip and the other part of the processor 1902 may be included in another chip. Otherwise, at least one processor may be included in another component, for example, the transceiver 1901 or the memory 1903.

The processor 1902 may perform or control or cause an operation of the BS 1900 for executing at least one or a combination of methods according to embodiments of the disclosure. For example, the processor 1902 may control operations of the BS 1900 for generating and transmitting a downlink signal to a UE or processing an uplink signal received from a UE. Otherwise, the BS 1900 may transmit or receive a signal to or from a neighboring BS, transfer a signal received from a UE to an upper node of the network, or transmit a signal transferred from an upper node of the network to a UE. To this end, the processor 1902 may execute a computer program, codes, or instructions stored in the memory 1903, so as to control other components of the BS 1900 to enable execution of various operations.

The memory 1903 corresponds to a hardware storage device capable of temporarily or permanently storing information and may include one or more storage media. For example, the memory 1903 may include memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1903 may be electrically, operatively, or communicatively coupled to the processor 1902 and may be accessed by the processor 1902.

The memory 1903 may store a computer program, codes, or instructions executable by the processor 1902. According to an embodiment, a computer program, codes, or instructions executable by the processor 1902 may be either stored in a single memory device or separated and distributedly stored in two or more memory devices. By executing the instructions stored in the memory 1903, the processor 1902 may perform various functions according to an embodiment of the disclosure.

According to an embodiment of the disclosure, operations of the BS 1900 may be caused to be performed based on execution of instructions (or a computer program or codes) stored in the memory 1903 by at least one processor (or processing circuitry) configured to execute the same individually, collectively, or in any combination thereof, based on processing circuitry that is not configured to execute instructions, and/or based on components of processing circuitry that is not configured to execute instructions.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE), the method comprising:
receiving, from a base station, information configuring channel measurement resources (CMRs);
generating a first subset of the CMRs corresponding to a transmission hypothesis and a second subset of the CMRs corresponding to an interference hypothesis; and
transmitting, to the base station, a channel state information (CSI) report including a first CSI for the first subset and a second CSI for the second subset.

2. The method of claim 1, wherein the first subset and the second subset are based on a threshold value of a reference signal received power (RSRP).

3. The method of claim 1, wherein the CSI report comprises a bitmap indicating at least one CMR for the first subset and the second subset.

4. The method of claim 1, wherein the CSI report comprises:
a first bitmap indicating a CMR for the first subset; and
a second bitmap indicating a CMR for the second subset.

5. The method of claim 1, further comprising:
selecting at least one transmission reception point (TRP) associated with the first subset.

6. The method of claim 1, wherein a frequency domain granularity of the second subset is coarser than a frequency domain granularity of the first subset.

7. The method of claim 1, wherein a reporting periodicity of the second subset is longer than a reporting periodicity of the first subset.

8. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, information configuring channel measurement resources (CMRs),
generate a first subset of the CMRs corresponding to a transmission hypothesis and a second subset of the CMRs corresponding to an interference hypothesis, and
transmit, to the base station, a channel state information (CSI) report including a first CSI for the first subset and a second CSI for the second subset.

9. The UE of claim 8, wherein the first subset and the second subset are based on a threshold value of a reference signal received power (RSRP).

10. The UE of claim 8, wherein the CSI report comprises a bitmap indicating at least one CMR for the first subset and the second subset.

11. The UE of claim 8, wherein the CSI report comprises:
a first bitmap indicating a CMR for the first subset; and
a second bitmap indicating a CMR for the second subset.

12. The UE of claim 8, wherein the instructions further cause the UE to:
select at least one transmission reception point (TRP) associated with the first subset.

13. The UE of claim 8, wherein a frequency domain granularity of the second subset is coarser than a frequency domain granularity of the first subset.

14. The UE of claim 8, wherein a reporting periodicity of the second subset is longer than a reporting periodicity of the first subset.

15. One or more non-transitory computer-readable storage media storing one or more computer programs including computer-executable instructions that, when executed by one or more processors of a user equipment (UE) individually or collectively, cause the UE to perform operations, the operations comprising:
receiving, from a base station, information configuring channel measurement resources (CMRs);
generating a first subset of the CMRs corresponding to a transmission hypothesis and a second subset of the CMRs corresponding to an interference hypothesis; and
transmitting, to the base station, a channel state information (CSI) report including a first CSI for the first subset and a second CSI for the second subset.
